(19) United States
(12) Patent Application Publication
(10) Pub. No.: US 2005/0122321 A1
(43) Pub. Date: Jun. 9, 2005

(54) Driver for driving a display device

(76) Inventors: Akihito Akai, Yokohama (JP); Yasuyuki Kudo, Fujisawa (JP); Takuya Eriguchi, Yokosuka (JP); Kazuo Okado, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/006,709

(22) Filed: Dec. 8, 2004

(30) Foreign Application Priority Data
Dec. 8, 2003 (JP) 2003-409001
Nov. 1, 2004 (JP) 2004-317690

(51) Int. Cl. G09G 5/00

(52) U.S. Cl. 345/204

(57) ABSTRACT

A driver for driving a display device, which has signal lines arranged in a first direction, scanning lines arranged in a second direction intersecting with the first direction, and pixels provided to correspond to intersections of the signal lines and the scanning lines, each pixel having a pixel electrode connected to the signal line through a capacitance and a switching element whose first, second, and third terminals are connected respectively to the signal line, the scanning line, and the pixel electrode, comprises: a converter for converting inputted display data to a gray-scale voltage and outputting the gray-scale voltage to the signal lines; and a switching circuit for opening/closing a first electrical coupling provided between the signal line and the converter and a second electrical coupling provided between the signal lines, wherein one scanning period for scanning the scanning lines includes a first period during which the switching circuit closes the first electrical coupling and opens the second electrical coupling, and a second period during which the switching circuit opens the first electrical coupling and closes the second electrical coupling.

### CROSS-REFERENCE TO RELATED APPLICATION

The present application claims priority from Japanese patent application No. JP 2003-409001 filed on Dec. 8, 2003 and No. 2004-317690 filed on Nov. 1, 2004, the contents of which are hereby incorporated by reference into this application.

### BACKGROUND OF THE INVENTION

The present invention relates to a driver (drive circuit) for driving a display device, which generates gray-scale voltages in accordance with display data and outputs them to an active matrix display panel such as a liquid crystal display panel, and especially to a driver for driving a display device, which is capable of reducing image quality deterioration called vertical smear in alternating-current drive in which low-power drive is operable during a frame period.

In the following description, a liquid crystal display panel, which is seemed to be now most widespread in display panels, is picked up as a representative example of the display panels and will be described.

In conventional liquid crystal panels for mobile devices as represented by cellular phones, attainment of low-power consumption thereof has been an essential problem. Therefore, by adopting a liquid-crystal drive method in which an alternating-current period of a voltage applied to the liquid crystal panel is changed to a frame period, the attainment of low-power consumption has been made. However, if the drive method in which the alternating-current period is changed in the form of a frame period is adopted, it is known that the image quality deterioration called vertical smear is generated. Meanwhile, since enlargement in size and high accuracy of displays are progressively being made in a field of current mobile equipment such as cellular phones, it has been figured out that the above-described image quality deterioration due to vertical smear cannot be ignored. For this reason, the drive method, in which a line period is changed in the form of an alternating-current period and which is expected to reduce the image quality deterioration caused by the vertical smear, becomes the mainstream of the liquid-crystal drive method.

As described above, if an alternating-current period at a time of the liquid-crystal drive is changed to a frame period, the low-power consumption thereof can be achieved. However, for example, in a black-rectangular display pattern in a middle gray-scale background as shown in FIG. 1A, display luminance in area II becomes, as shown in FIG. 1B, darker than display luminance in area I and the image quality deterioration called vertical smear in which vertical stripes occur is found out. In contrast, if a drive method in which a line period is changed in the form of an alternating-current period is adopted, it is known that the above-described image quality deterioration due to vertical smear is improved. However, in this case, an increase in power consumption occurs because the alternating-current period becomes short.

It has been found out that cause of the vertical smear is that fluctuations of the signal line at a time of applying the gray-scale voltage are propagated to a pixel electrode by coupling capacitance in the liquid crystal panel. FIG. 1C shows a pixel structure of a liquid crystal display panel, specifically, shows that fluctuations of a signal line Dn2 are propagated to a pixel electrode S by coupling capacitance Cds and capacitance Cds' illustrated in one circle and a voltage Vs of the pixel electrode S is fluctuated. FIG. 1D is a view showing a scanning line G0, an opposite electrode COM, a signal line Dn, an applied voltage Vs to the pixel electrode S, and a voltage effective value Vrms at the time of applied thereto, all of which are included in the display pattern of FIG. 1A. However, the voltage level of the signal line Dn1 does not fluctuate during one frame period while that of the signal line Dn2 fluctuates at the time of displaying the black-rectangular pattern. These fluctuations are propagated through the capacitance Cds and the capacitance Cds' to the pixel electrode S, so that the pixel voltage Vs2 in the area II decreases while the pixel voltage Vs1 in the area I remains unchanged. Consequently, the effective value Vrms2 of the pixel in the area II is made lower than the effective value Vrms1 of the pixel in the area I, so that the image quality deterioration called vertical smear, in which a difference between the display luminance of both is generated, occurs.

Note that the fluctuations of the voltage level of the pixel electrode similarly occur by coupling the capacitance Cds and the capacitance Cds' even in the drive method in which the line period is changed in the form of an alternating-current period. However, the image quality deterioration due to vertical smear does not occur since the fluctuated direction of the signal line is switched to a positive or negative polarity per line and the fluctuations of the pixel electrode are canceled. At this time, if the alternating-current period is changed in the form of the line period, alternating-current frequency of the applied voltage rises and a charge/discharge current in the liquid crystal panel is increased.

As a conventional technique disclosing that a plurality of signal lines are short-circuited therebetween, Japanese Patent Laid-open No. 11-85115 discloses a liquid crystal device making a polarity inversion drive, wherein before respective pieces of pixel data are written to a plurality of data signal lines (112), pre-charge is executed by simultaneously turning on pre-charging switches (172) and short-circuiting the data signal lines adjacent to each other. At this time, a pre-charge potential (PV) is set to a middle potential (6V) of a voltage amplitude (1 v to 11 v) to be applied to a liquid crystal cell (114). If a sampling switch (106) is formed of an n-type transistor, the pre-charge potential is set to a lower potential (5.5 V) than the middle potential. Alternatively, if a sampling switch (106) is formed of a p-type transistor, the pre-charge voltage is set to a higher potential (6.5 V) than the middle potential.

Also, Japanese Patent Laid-open No. 2001-134245 as a conventional technique discloses a liquid crystal display device comprising: a display area in which a plurality of gate lines as rows and a plurality of signal lines 12-1, 12-2, . . . as columns are arranged on a substrate in matrix and on which pixels are disposed at respective intersections of both lines; and a horizontal driver for outputting reversed polarity pixel signals to the adjacent signal lines 12-1, 12-2, . . . from respective output terminals 15-1, 15-2, . . . and for reversing the polarities of the pixel signals outputted to the respective signal lines 12-1, 12-2, . . . per horizontal scanning period, wherein CMOS switches made from thin film transistors using polycrystalline silicon are provided, on the substrate, as reset switches 31-1, 31-2, . . . for short-circuiting the signal lines 12-1, 12-2, . . . to which the reversed polarity pixel signals are applied during a blanking period in one horizontal scanning period.

### SUMMARY OF THE INVENTION

The present invention has been premised on the fact that the liquid crystal drive method in which a frame period is converted to an alternating-current waveform in order to maintain an advantage of the low-power consumption. If the voltage of the signal line Dn1 as shown in FIG. 2 is dropped to decrease the effective value Vrms1 and the voltage of the signal line Dn2 is risen to increase the effective value Vrms2, an effective-value difference (Vrms1−Vrms2) becomes small. Therefore, it has been found that the vertical smear can be improved. Note that although only the image quality deterioration occurring in the area II is explained in the foregoing description, any image quality deterioration occurs also under or/and below the black-rectangular pattern caused by the same coupling operation described in FIG. 1B. However, since this point can be thought as the same, its description will be omitted in this specification.

Accordingly, a switch is provided between outputs adjacent to each other in a signal line driver, and the adjacent signal lines are short-circuited during a signal-line short-circuit period LEQ as shown in FIG. 2. Note that the signal-line short-circuit period is provided in a first or last half of one scanning period.

Outlines of representative ones of inventions disclosed in the present application will be described as follows.

A driver for driving a display device according to the present invention comprises a switching circuit for opening/closing a first electrical coupling provided between a plurality of signal lines on a display panel and a converter for converting inputted display data to a gray-scale voltage and outputting said converted gray-scale voltage to said signal lines and for opening/closing a second electrical coupling provided between said plurality of signal lines, wherein one scanning period for scanning said scanning lines includes a first period (a period during which said gray-scale voltage is applied to said signal lines) during which said switching circuit closes said first electrical coupling and opens said second electrical coupling, and a second period (a period during which the plurality of signal lines are short-circuiting therebetween) during which said switching circuit opens said first electrical coupling and closes said second electrical coupling.

According to the present invention, the plurality of signal lines are short-circuited therebetween to change each potential of the plurality of signal lines in the display panel to the same potential. Thereby, regarding the display pattern in FIG. 1A for example, as shown in FIG. 2, the pixel in which the effective value is decreased by the fluctuations of the signal Dn2 is such that the effective value is increased in the second period LEQ, and the pixel having the original effective value is such that the effective value is decreased in the second period LEQ. For this reason, since an effective-value difference between both pixels becomes small, vertical smear is reduced. Note that if the second period LEQ is set to be one half of the one scanning period, the effective-value difference can be reduced up to one half thereof.

As thus described above, the image quality deterioration called vertical smear is reduced by using the drive method in which a frame period is changed in the form of an alternating-current period. Thereby, it is possible to reduce low-power consumption and improve image quality.

### BRIEF DESCRIPTION OF THE DRAWINGS

FIG. 1A is a view showing a display pattern in which vertical smear appears significantly.

FIG. 1B is a view showing image quality deterioration caused by vertical smear in the display pattern of FIG. 1A.

FIG. 1C is a view showing a pixel configuration of a liquid crystal panel having a storage line structure.

FIG. 1D is a timing diagram showing a voltage waveform applied to each polarity (voltage) of a liquid crystal panel when a drive method in which an alternating-current period is changed in the form of a frame period is adopted and when the display pattern as shown in FIG. 1A is displayed.

FIG. 2 is a view showing an effect obtained by short-circuiting of signal lines, which is related to the present invention.

FIG. 3 is a block diagram showing a configuration of a liquid crystal display device according a first embodiment of the present invention.

FIG. 4A is a block diagram showing a configuration of a short-circuit period adjusting circuit in a signal-line driver, which is related to a first embodiment of the present invention.

FIG. 4B is a timing diagram showing operation timing of a short-circuit period adjusting circuit and an applied voltage waveform in a liquid crystal panel, which is related to a first embodiment of the present invention.

FIG. 5 is a block diagram showing a configuration of a liquid crystal display device according to a second embodiment of the present invention.

FIG. 6 is a block diagram showing a configuration of a liquid crystal display device according to a third embodiment of the present invention.

FIG. 7 is a block diagram showing a configuration of a short-circuit period adjusting circuit in a signal-line driver, which is related to a third embodiment of the present invention.

FIG. 8 is a timing diagram showing operation timing of a short-circuit period adjusting circuit and an applied voltage waveform in a liquid crystal panel, which is related to a third embodiment of the present invention.

FIG. 9 is a block diagram showing a configuration of a liquid crystal display device according to a fourth embodiment of the present invention.

FIG. 10A is a block diagram showing a configuration of a liquid crystal display device according to a fifth embodiment of the present invention.

FIG. 10B is a view showing a formula for computing an outputted voltage of a drive detecting circuit, which is related to a fifth embodiment of the present invention.

FIG. 10C is a table showing a relation between the selected number of signal lines and an outputted voltage of a drive detecting circuit.

FIG. 11A is a block diagram showing a configuration of a liquid crystal display device according to a sixth embodiment of the present invention.

FIG. 11B is a table showing a relation between a maximum/minimum gray-scale of display data and a variable resistance value, which is related to a sixth embodiment of the present invention.

FIG. 11C is a view showing an effect obtained by a maximum/minimum gray-scale detection, which is related to a sixth embodiment of the present invention.

FIG. 12A is a block diagram showing a configuration of a liquid crystal display device according to a seventh embodiment of the present invention.

FIG. 12B is a table showing a relation among the maximum gray-scale of display data, a variable resistance value, a backlight drive voltage, and a luminance, which is related to a seventh embodiment of the present invention.

FIG. 12C is a view showing an effect obtained by a maximum gray-scale detection and a backlight-luminance adjusting function, which is related to a seventh embodiment of the present invention.

### DESCRIPTION OF THE PREFERRED EMBODIMENTS

The present invention relates to a display device that uses an active matrix display panel. However, as described above, it is a liquid crystal display panel that is now generally the most widespread among display panels, and so the liquid crystal display panel is taken as a representative example of the display panels and will be described in detail. On the other hand, needless to say, as described later, the present invention may be applied to the case of using an active matrix display panel other than the liquid crystal panel, for example, the case of an electroluminescent (EL) display panel.

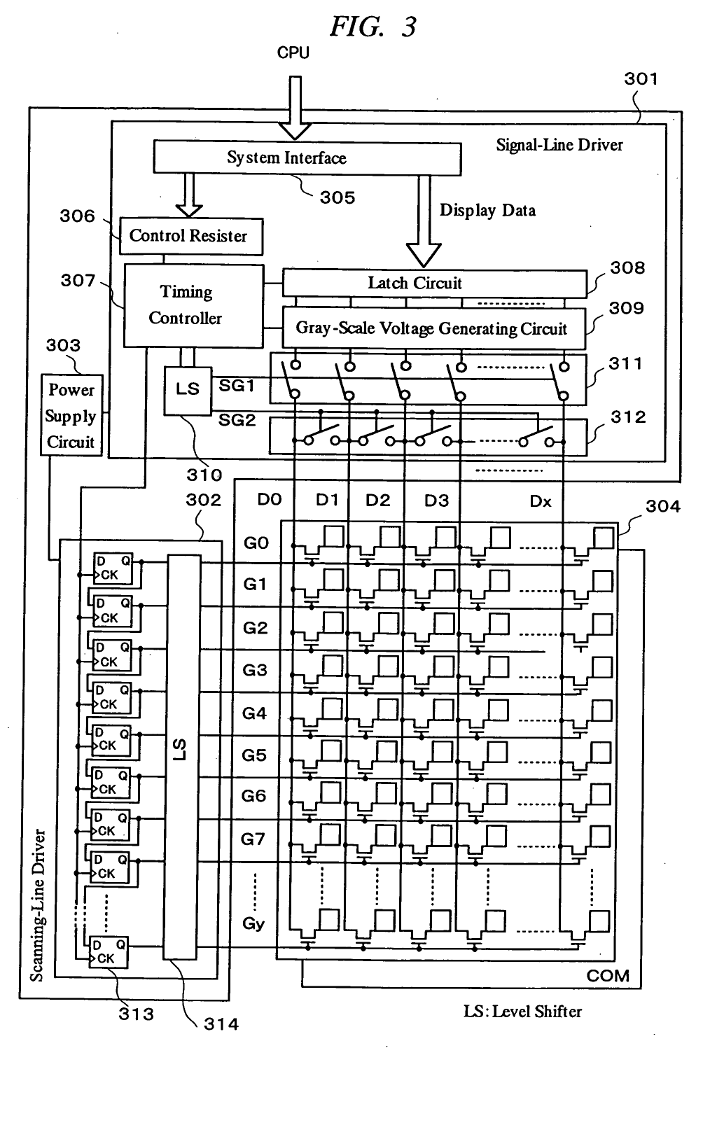

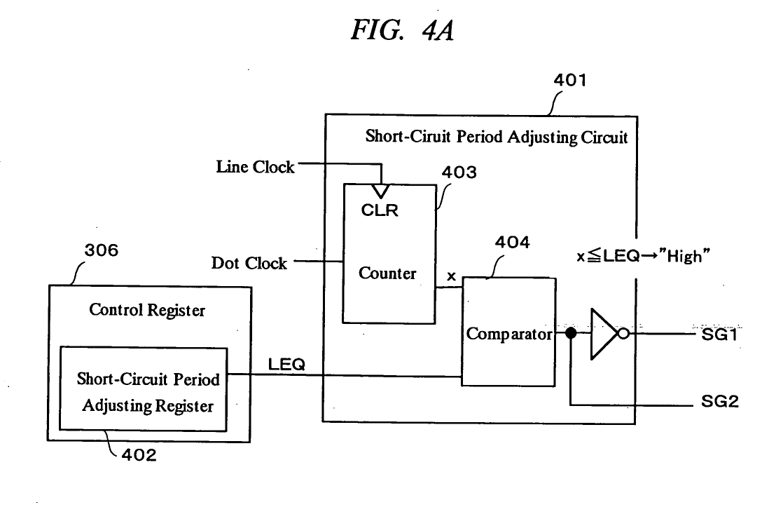

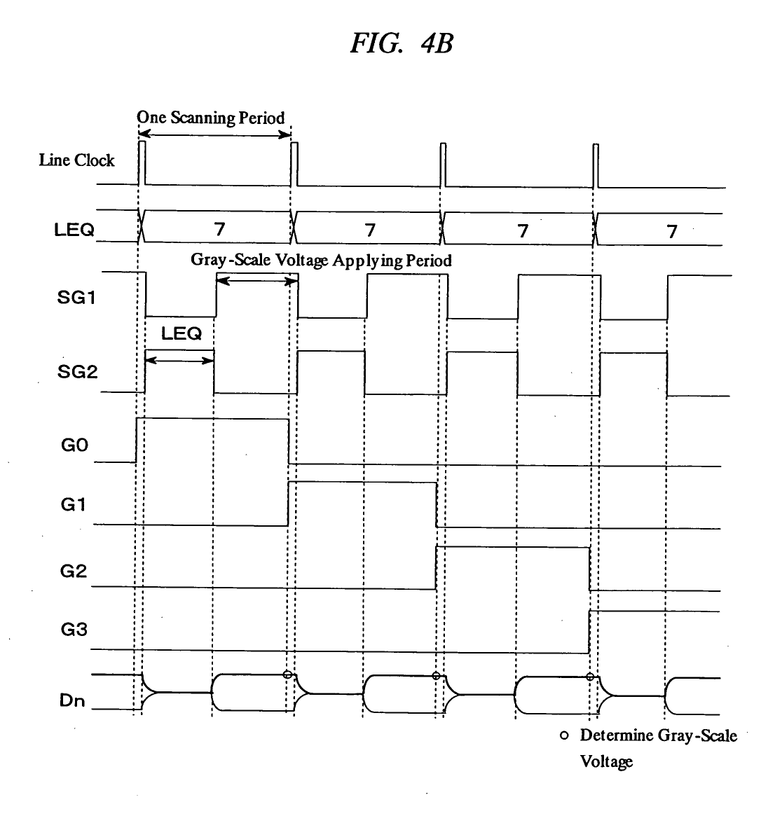

A configuration of a liquid crystal display device according to a first embodiment of the present invention will be described using FIGS. 3 and 4.

Firstly, FIG. 3 is a block diagram of a liquid crystal display device according to a first embodiment of the present invention, wherein the reference numeral “301” denotes a signal-line driver; “302” a scanning-line driver; “303” power supply circuit; “304” a liquid crystal panel; “305” a system interface; “306” is a control register; “307” a timing controller; “308” a latch circuit; “309” a gray-scale voltage generating circuit; “310” a level shifter; “311” a switch; “312” a switch; “313” a shift register; and “314” a level shifter.

The liquid crystal panel 304 is an active matrix type in which TFTs are provided per pixel and signal lines and scanning lines connected to the TFTs are arranged in matrix.

The scanning line driver 302 applies scanning pulses for sequentially turning on the TFTs in line order, to the scanning lines in the liquid crystal panel 304.

The signal-line driver 301 applies a gray-scale voltage to pixel electrodes connected to respective source terminals of the TFTs through the signal lines. Note that an effective value applied to liquid crystal molecules is changed by the gray-scale voltage applied to the pixel electrodes, whereby display luminance can be controlled.

Next, an operation of each of blocks constituting the signal line driver 301 and the scanning line driver 302 will be described.

The system interface 305 receives display data and an instruction outputted from a CPU, and outputs them to the control register 306. The detailed operation is based on, for example, “System interface” described in the interim specification Rev 0.6 of “384 channel segments' driver HD 66763 that displays 256 colors and is build in RAM” published by Semiconductor Group of Hitachi, Ltd. In this case, the “instruction” means information for determining internal operations of the signal-line driver 301 and the scanning-line driver 302, and includes various parameters such as a frame frequency, the number of drive lines, the number of colors, and setting of a signal-line short-circuit period.

The timing controller 307 has a dot counter and counts dot clocks to generate line clocks. Note that the timing controller 307 includes a short-circuit period adjusting circuit for generating signals SG1 and SG2 which define the operation timing of the switches 311 and 312.

The control register 306 has a latch circuit built-in and transfers the signal-line short-circuit period adjusting value LEQ from the system interface, to the short-circuit period adjusting circuit in the timing controller 307. Note that the control register 306 has a signal-line short-circuit period adjusting register for holding the signal-line short-circuit period adjusting value LEQ.

The latch circuit 308 operates at a time of falling timing of the line clock and transfers one-line display data to the gray-scale voltage generating circuit 309.

The gray-scale voltage generating circuit 309 generates gray-scale voltage levels capable of displaying a plurality of gray-scales and plays a role of a DA converter for converting digital display data transferred from the latch circuit 308, to analog gray-scale voltage levels, through the built-in decoder circuit, level shifter, and selector circuit. Note that an Op-AMP for applying the gray-scale voltage to the signal lines may be located on an input side of the selector circuit or on an output side.

The level shifter 310 converts the signal SG1 for controlling the switch 311 and the signal SG2 for controlling the switch 312 which are transferred from the timing controller 307, from Vcc-GND levels to VDD-GND levels, and then transfers the signals to the switches 311 and 312.

The switch 311 controls the signal SG1 which becomes “0” (low) in a signal-line short-circuit period LEQ and “1” (high) in a period other than the signal-line short-circuit period LEQ. Note that in the present embodiment, when the signal SG1 is “0” (low) and the switch 311 is turned off, the output of the gray-scale voltage generating circuit 309 in the signal-line driver 301 is set to high impedance. Further, when the signal SG1 is “1” (high) and the switch 311 is turned on, the signal-line driver 301 applies a gray-scale voltage to the signal lines.

The switch 312 controls the signal SG2 which becomes “1” (high) in the signal-line short-circuit period LEQ and becomes “0” (low) in a period other than the period LEQ. Note that in the present embodiment, when the signal SG2 is “1” (high), the switch 312 is turned on and all of the signal lines in the liquid crystal panel are short-circuited and are once changed to the same potential. Then, when the signal SG2 is “0” (low), the switch 312 is turned off and connections among the respective signal lines are released.

The shift register 313 synchronizes with the line clock transferred from the timing controller 307 and sequentially generates scanning pulses to the scanning lines G0 to Gy in line order. Note that a high-pulse width of the pulse generated at this time becomes one scanning period.

The level shifter 314 converts a Vcc-GND level of the scanning pulse transferred from the shift register 313, to a VGH-VGL level, and outputs it to the liquid crystal panel 304. Note that “VGH” is a voltage level at which the TFTs are turned on and “VGL” is a voltage level at which the TFTs are turned off.

Next, each control of the switches 311 and 312 related to the present invention will be described together with the short-circuit period adjusting circuit in the timing controller 307 with reference to FIG. 4A.

The reference numeral “401” denotes a short-circuit period adjusting circuit for adjusting the operation timing of the switches 311 and 312; “402” a short-circuit period adjusting register for holding the short-circuit adjusting value LEQ which defines the operation timing of the switches 311 and 312; “403” a counter; and “404” a comparator.

The counter 403 counts the dot clock. The comparator 404 compares an output X of the counter 403 and the short-circuit period adjusting value LEQ transferred from the short-circuit period adjusting register 402 and generates the signal SG1 for controlling the switch 311 and the signal SG2 for controlling the switch 312. In the present embodiment, the comparator 404 outputs “1” (high) under the condition of X≦LEQ, and outputs “0” (low) under the condition of X>LEQ.

Next, each control of the switches 311 and 312 will be described using a timing chart of each signal as shown in FIG. 4B.

Firstly, a scanning pulse is applied to a scanning line G0 and all of the TFT switches disposed on a first row of the panel are turned on. Next, the switch 311 connected to the output of the gray-scale voltage generating circuit 309 is turned off in synchronism with the falling of the signal SG1, and the switch 312 connected between the signal lines is turned on in synchronism with the rising of the signal SG2. Therefore, the connection between the signal lines is short-circuited and the voltage levels of all the signal lines are once changed to the average voltage levels. Then, the switch 312 is turned off in synchronism with the falling of the signal SG2, and the switch 311 is turned on in synchronism with the rising of the signal SG1. Therefore, the signal-line driver 301 applies the gray-scale voltage to the pixel electrodes through the signal lines and the TFTs. Then, when the voltage level of the scanning line G0 becomes VGL and the TFTs are turned off, the voltage level of the pixel electrode disposed on the first row of the panel is decided. Note that supplying a steady-state current to an Op-AMP circuit for outputting the gray-scale voltage in the signal-line driver 301 is stopped during the signal-line short-circuit period LEQ during which all of the signal lines are short-circuited and thereby the low-power consumption may be achieved.

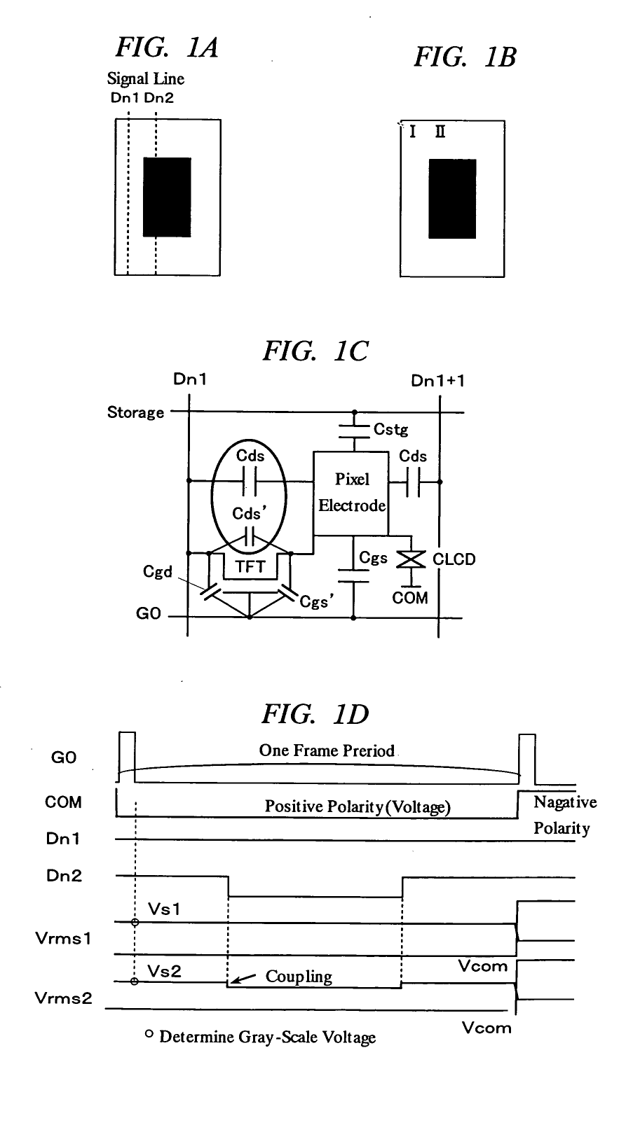

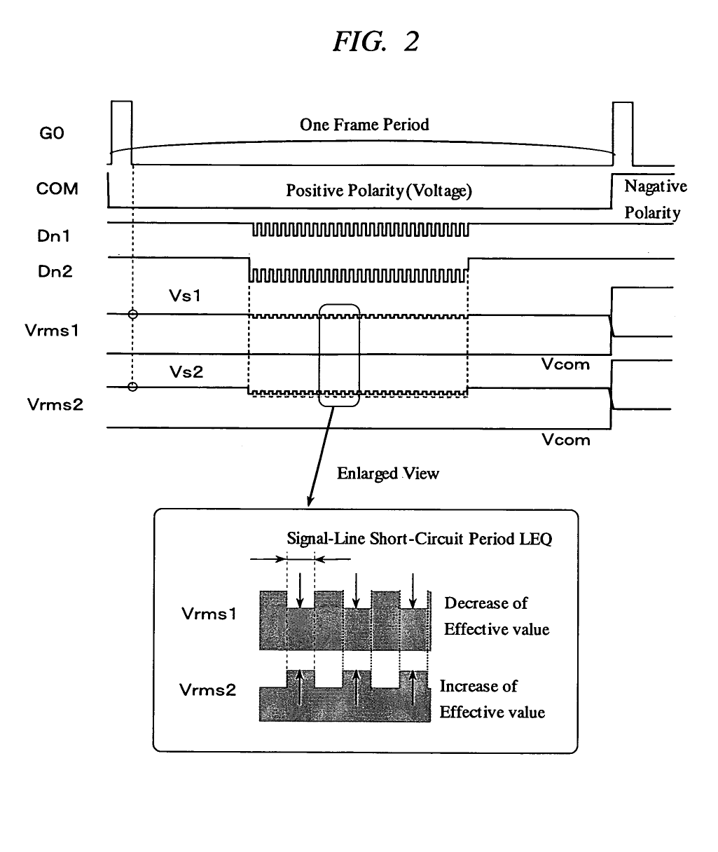

Thus, for example, the signal lines Dn1 and Dn2, the pixel voltages Vs1 and Vs2 in the areas I and II, and the effective values Vrms1 and Vrms2 in the display pattern as shown in FIG. 1A become shown in FIG. 2. At this time, since the voltage level of the signal line Dn2 increases during the signal-line short-circuit period LEQ, the pixel voltage Vs2 in the area II also increases by coupling the capacitors Cds and Cds′. Consequently, the effective value Vrms2 is increased. Also, since the voltage level of the signal line Dn1 decreases during the signal-line short-circuit period LEQ, the pixel voltage Vs1 in the area I also decreases by coupling the capacitors Cds and Cds′. Consequently, the effective value Vrm1 is reduced. Therefore, the effective-value difference (Vrms1−Vrms2) becomes small and a difference of luminance therebetween is also reduced, so that the image quality deterioration caused by vertical smear can be reduced.

In the case of adopting the circuit configurations and the operation timing as described above, even if the drive method in which the alternating-current period is changed in the form of the frame period is used, the image quality deterioration called vertical smear can be reduced and both of low-power consumption and high-image quality can be achieved.

Note that the present invention adopts an active matrix panel, which shares the signal lines in a vertical or horizontal direction, and so long as any panels can control the display luminance by voltage levels, they may be applied. Therefore, if satisfying the above-described condition, any panels other than the liquid crystal panel described in this embodiment, for example, organic EL panels and/or any display devices other than them may be applied. In this case, to each pixel of the display devices, there is provided an optical modulating layer for modulating an amount of light which passes through or is reflected from each pixel in accordance with the supplied gray-scale voltage, e.g., a liquid crystal layer, or provided a light emitting layer for modulating an amount of light irradiated in accordance with the gray-scale voltage, e.g., an electroluminescent (EL) layer. The polarity of the voltage applied to the light modulating layer or light emitting layer is periodically reversed during the alternating-current period drive.

Also, the driver according to the present invention may have a built-in or unbuilt-in display RAM in the present embodiment.

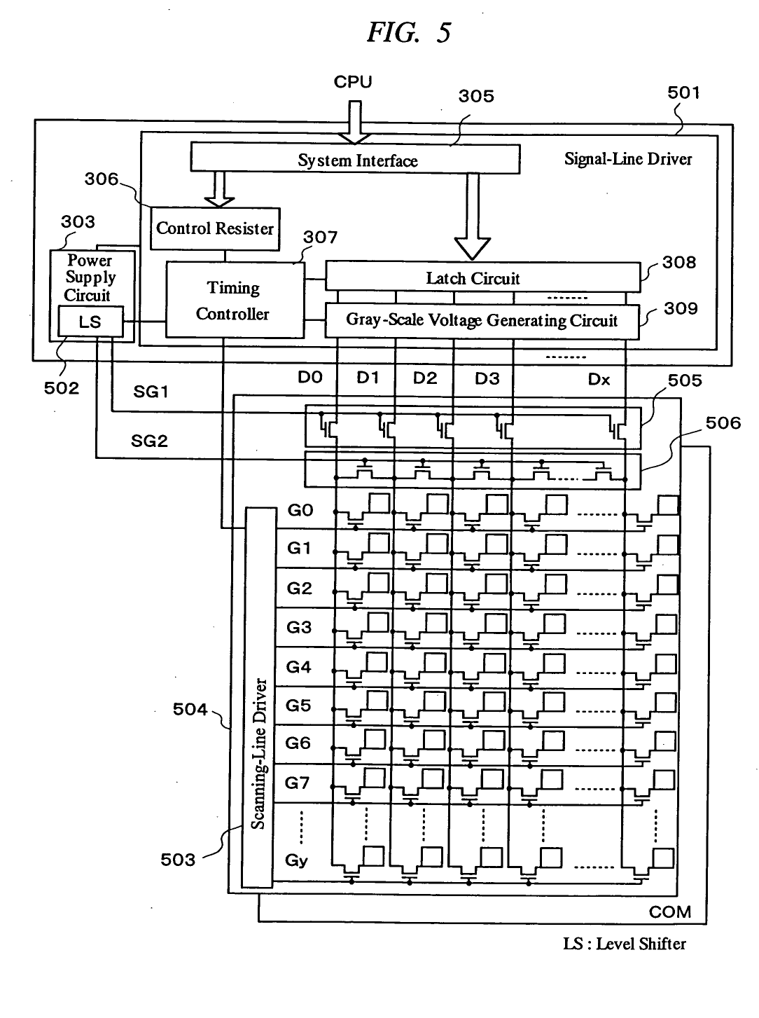

A configuration of a liquid crystal driver according to a second embodiment of the present invention will be described using FIG. 5.

A second embodiment of the present invention uses a scanning driver 503, a switch 505, and a switch 506, which are changed in layout instead of the scanning driver 302, the switch 311, and the switch 312 in the first embodiment.

FIG. 5 is a block diagram of a liquid crystal display device according to a second embodiment of the present invention, wherein the reference numeral “501” denotes a signal-line driver; “502” a level shifter; “503” a scanning-line driver; “504” a liquid crystal panel; “505” a switch; “506” a switch; “303” the power supply circuit; “305” the system interface; “306” the control register; “307” the timing controller; “308” the latch circuit; and “309” the gray-scale voltage generating circuit. The liquid crystal panel 504 in them has an active matrix configuration in which the TFTs are disposed per pixel and the signal and scanning lines connected to the TFTs are arranged in matrix. Note that, in the present embodiment, the scanning-line driver 503 is built in the liquid crystal panel 504 (for example, the scanning-line driver 503 is made of low-temperature polysilicon on a substrate of the liquid crystal panel 504), and the liquid crystal display device comprises the signal-line driver 502 and the power supply circuit 303. The switches 505 and 506 are made of TFTs and are built in the liquid crystal panel 504 (for example, the switches 505 and 506 are made of low-temperature polysilicon on a substrate of the liquid crystal panel 504). Note that the above-described TFT may be an amorphous TFT or a low-temperature polysilicon TFT. Also, although the scanning-line driver 503 is built in the liquid crystal panel 504 in the present invention, it may not be built in.

Next, each operation of blocks constituting the signal-line driver 501 will be described.

The power supply circuit 303 supplies power sources to the signal-line driver 501 and the scanning-line driver 503 built in the liquid crystal panel 504. The level shifter 502 built in the power supply circuit 303 converts the Vcc-GND levels of the signals SG1 and SG2 generated in the timing controller 307, to the VGH-VGL levels that are operation power sources of the TFTs in the liquid crystal panel 504. Note that the reason for converting the Vcc-GND level to the VGH-VGL level is that the switches 505 and 506 is required to be controlled by voltages that depend on the operation power sources of the TFTs in the liquid crystal panel 504.

Note that the operation timing of the switches 505 and 506 is the same as that in the first embodiment.

In the case of using the circuit configuration and the operation timing as describe above, even if the drive method in which the alternating-current period is changed in the form of the frame period is adopted, the image quality deterioration called vertical smear can be reduced and both of low-power consumption and high-image quality can be achieved.

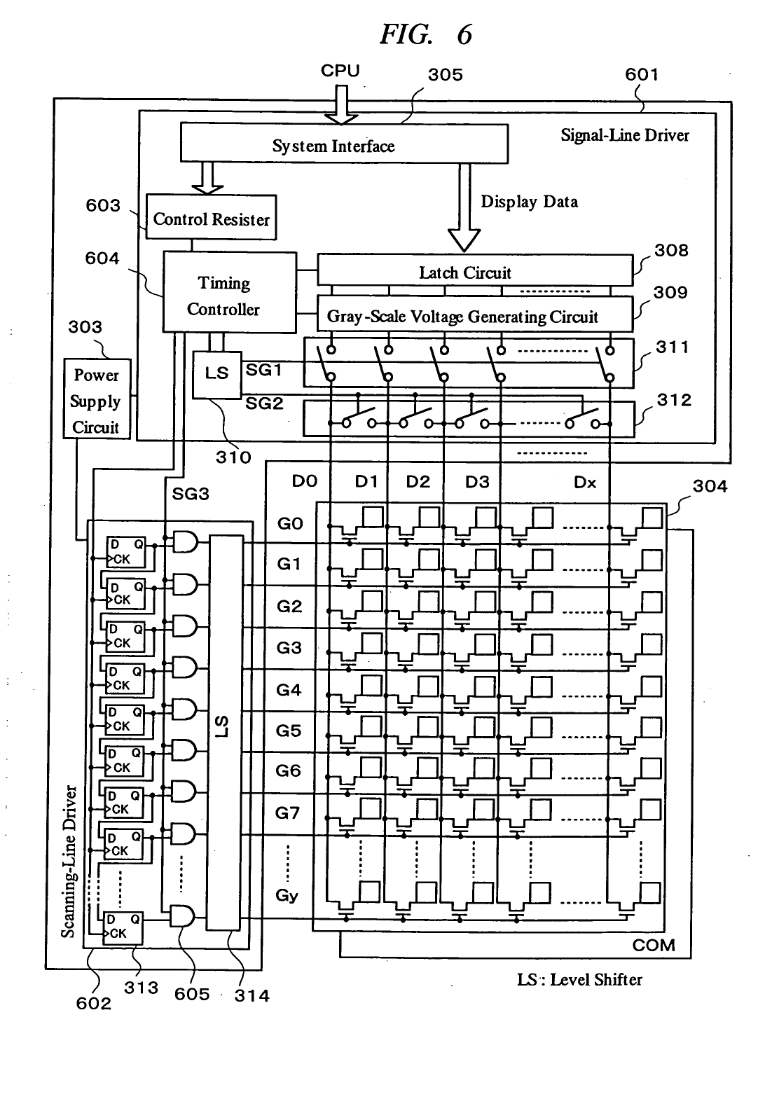

A configuration of a liquid crystal display device according to a third embodiment of the present invention will be described using FIGS. 6 to 8.

In the above-described first and second embodiments, since all of the signal lines are short-circuited during a period for selecting the scanning lines, the voltage levels of the pixel electrodes at a time of selection are fluctuated similarly to the signal lines in an area in which the voltage levels of the signal lines are fluctuated at a time of the short-circuiting. In contrast, since the voltage levels of the pixel electrodes are not fluctuated in an area in which the voltage levels of the signal lines are not fluctuated at a time of the short-circuiting, there is a possibility that the effective-value difference will occur depending on whether the signal lines are fluctuated at a time of the short-circuiting. Meanwhile, if the signal lines are short-circuited during a non-overlapping period during which all the scanning lines are not selected, the above-described voltage fluctuations of the pixel electrodes do not occur, so that the fluctuations of the effective values can be reduced. However, if the non-overlapping period is set, there is a possibility that lack of application of the gray-scale voltages to the pixel electrodes will be caused by influences of reduction of the selection period and delay of the TFTs provided per pixel. Therefore, in this embodiment, it is possible to adjust as well as set the non-overlapping period.

The third embodiment of the present invention can provide the signal-line short-circuit period LEQ and the non-overlapping period NO and set both periods by the control register 306.

FIG. 6 is a block diagram of a liquid crystal display device according to a third embodiment of the present invention, wherein the reference numeral “601” denotes a signal-line driver; “602” a scanning-line driver; “603” a control register; “604” a timing controller; and “605” an AND operation unit.

In this case, an operation of each block constituting the signal-line driver 601 and the scanning-line driver 602 will be described.

The system interface 305, the latch circuit 308, the gray-scale voltage generating circuit 309, the switch 311, the switch 312, the shift register 313, and the level shifter 314 are the same as those of the first and second embodiments of the present invention.

The timing controller 604 has a dot counter and counts a dot clock to generate a line clock. Also, the timing controller 604 includes a short-circuit period/non-overlapping period adjusting circuit for controlling the operation timing of the scanning-line driver 602 and the switches 311 and 312 of the present invention.

The control register 603 has the built-in latch circuit, operates at timing of the falling of the line clock from the timing controller 604, and transfers the signal-line short-circuit period adjusting value LEQ and the non-overlapping period value NO from the system interface, to the short-circuit period/non-overlapping period adjusting circuit in the timing controller 604. Note that the control register 603 has a non-overlapping period adjusting register for holding the non-overlapping period adjusting value NO, and a signal-line short-circuit period adjusting resister for holding the signal-line short-circuit period adjusting value LEQ.

The AND operation unit 605 executes calculation by the scanning pulses generated in the shift register 313 and the signal SG3 defining the non-overlapping period generated in the timing controller 604. Thereby, there is each scanning pulse having the non-overlapping period during which all of the scanning lines are not selected in the first half of one scanning period, and having the selecting period during which the scanning lines are selected in the last half period of one scanning period.

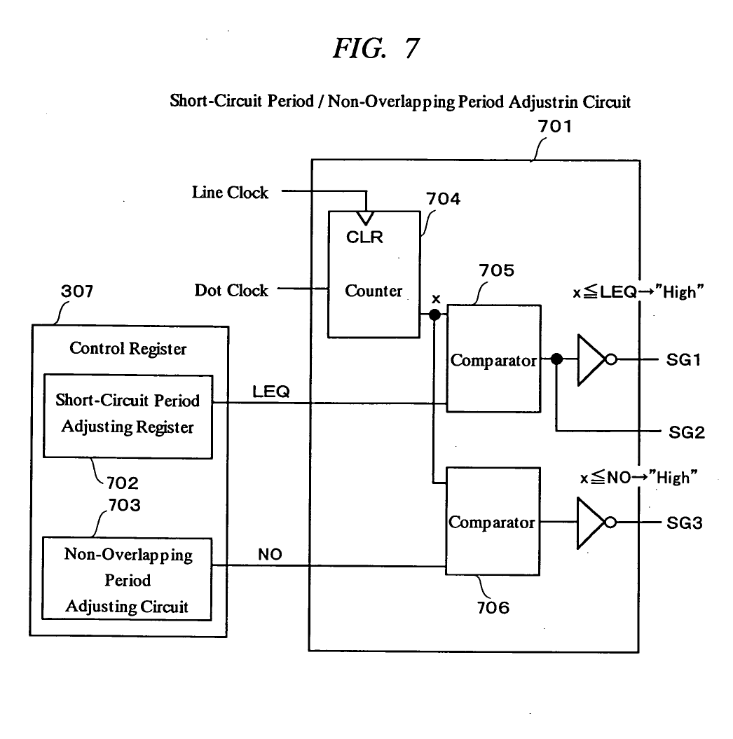

Next, each control of the scanning-line driver 602 and the switches 311 and 312 related to the present invention will be described together with the short-circuit period/non-overlapping period adjusting circuit in the timing controller 604 with reference to FIG. 7.

The reference numeral “701” denotes a short-circuit period/non-overlapping period adjusting circuit for adjusting the operation timing of the switches 311 and 312; “702” a short-circuit period adjusting register for holding the short-circuit period adjusting value LEQ, which defines the operation timing of the switches 311 and 312; “703” a non-overlapping period adjusting register for holding the non-overlapping period adjusting value NO, which defines the operation timing of the scanning-line driver 602; “704” a counter; “705” a comparator; and “706” a comparator.

The counter 704 counts a dot clock and is reset by a line clock.

The comparator 705 compares the output X of the counter 704 and the short-circuit period adjusting value LEQ transferred from the short-circuit period adjusting register 702, and generates the signal SG1 for controlling the switch 311 and the signal SG2 for controlling the switch 312. In the present embodiment, the comparator 705 outputs “1” (high) under the condition of X≦LEQ, and outputs “0” (low) under the condition of X>LEQ.

The comparator 706 compares the output x of the counter 704 and the non-overlapping period adjusting value NO transferred from the non-overlapping period adjusting register 703, and generates the signal SG3 for controlling the pulse width of the scanning pulse. In the present embodiment, the comparator 706 outputs “1” (high) under the condition of X≦NO, and outputs “0” (low) under the condition of X>NO.

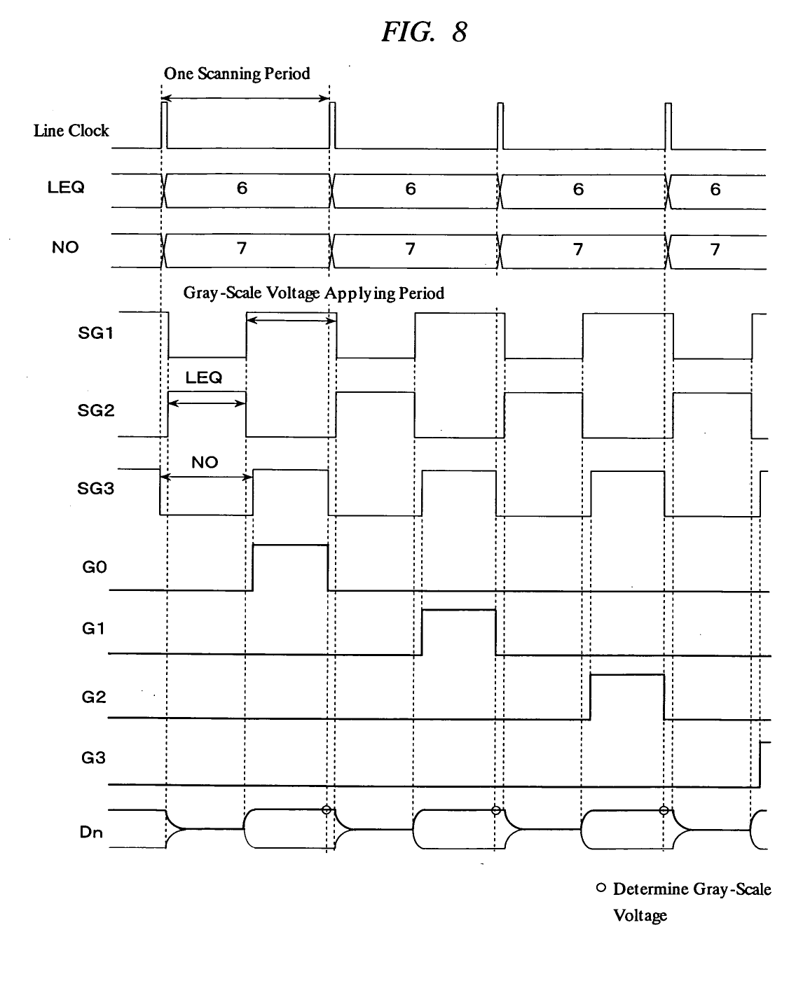

Next, a timing chart related to the present embodiment is shown in FIG. 8.

Firstly, the switch 311 connected to the output of the gray-scale voltage generating circuit 309 is turned off in synchronization with falling of the signal SG1, and the switch 312 connected between the signal lines is turned on in synchronism with rising of the signal SG2. Therefore, the voltage levels of the signal lines are changed to an average voltage level of all the signal lines. Then, the switch 312 is turned off in synchronism with falling of the signal SG2, and the switch 311 is turned on in synchronism with rising of the signal SG1. Therefore, the signal-line driver 601 applies the gray-scale voltage to the signal lines. Further, the scanning pulse is applied to the scanning line G0 in synchronism with rising of the signal SG3, and all of the TFT switches located on the first row of the panel are turned on. At this time, the signal-line driver 601 applies the gray-scale voltage to the pixel electrodes through the signal lines and the TFTs. Note that a relation between the signal-line short-circuit period LEQ and the non-overlapping period NO is preferably LEQ<NO in the present embodiment. Thereby, since the signal lines are not short-circuited during a period during which the pixels are selected, it is possible to achieve measures for preventing the vertical smear due to short-circuit of the signal lines without involving unnecessary voltage fluctuations. Note that the first and second embodiments can be exchanged with the third embodiment because the non-overlapping period NO can be adjusted.

Also in the present embodiment, although the signal-line short-circuit period LEQ and the non-overlapping period NO are set to the first half of the one scanning period, they may be set to the last half of the one scanning period. Additionally, the switches 311 and 312 may be built in the liquid crystal panel 304 similarly to the second embodiment.

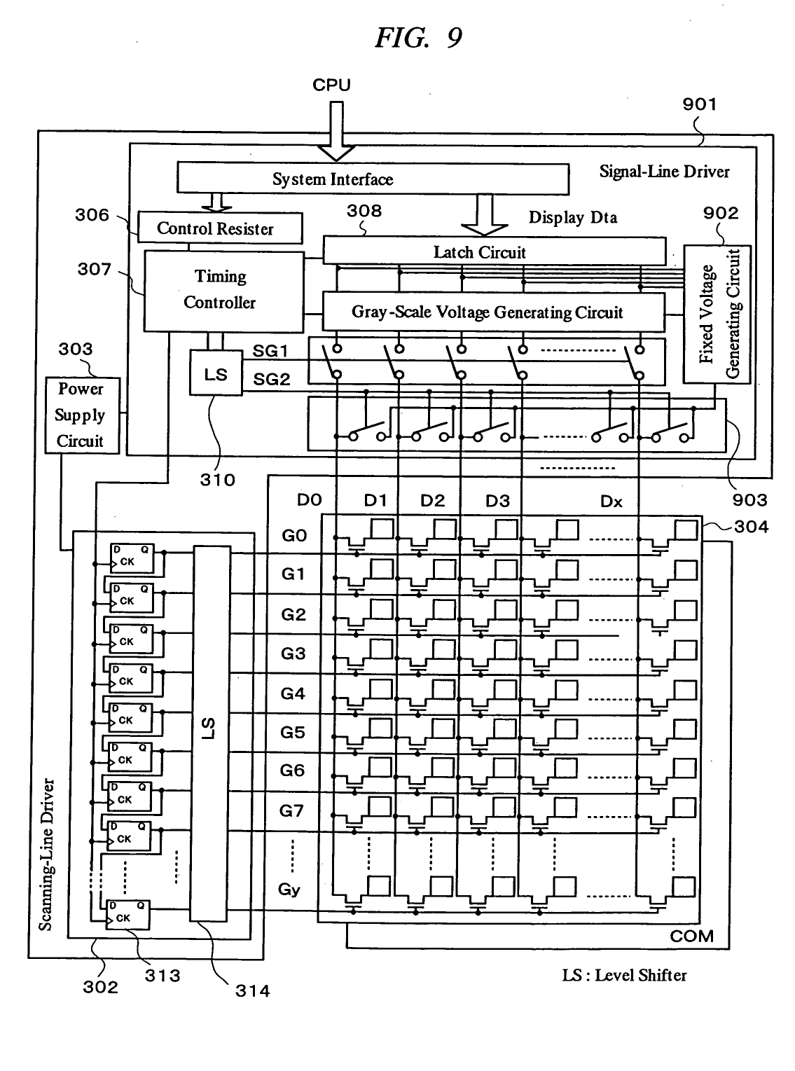

A configuration of a liquid crystal display device according to a fourth embodiment of the present invention will be described using FIG. 9. In a fourth embodiment of the present invention, a specific voltage level which is calculated based on the display data is applied to the signal lines instead of short-circuiting of the signal lines, whereby there are taken measures for preventing the image quality deterioration caused by vertical smear. Note that the display data indicated at this time is represented by 6 bits if the liquid crystal display device can display 64 gray-scales. In the present embodiment, an average gray-scale is calculated per one row from the 6-bit display data, and the gray-scale voltage based on the calculated average gray-scale is applied to all of the signal lines in the first or last half of the one scanning period.

FIG. 9 is a block diagram of a liquid crystal display device according to a fourth embodiment of the present invention, wherein the reference numeral “901” denotes a signal-line driver; “902” a fixed voltage generating circuit; and “903” a switch. Now, an operation of each of the blocks constituting the signal-line driver 901 and the scanning-line driver 302 will be described.

The system interface 305, the latch circuit 308, the gray-scale voltage generating circuit 309, the switch 311, the shift register 313, and the level shifter 314 are the same as those of the first, second, and third embodiments. Also, the timing controller 307 and the control register 306 may be the same as those of the first and second embodiments of the present invention or may be the same as those of the third embodiment.

Firstly, the fixed voltage generating circuit 902 calculates an average gray-scale of the one-line display data transferred in parallel from the latch circuit 308. Then, the fixed voltage generating circuit 902 applies, to the signal lines, a gray-scale voltage obtained based on the average gray-scale calculated by the built-in decoder circuit, level shifter, selector circuit, and Op-AMP. Note that when the average gray-scale is calculated, all of the bits of the display data may not be used. For example, by using the only high order 2 bits, an increase in circuit size due to use of the circuit for calculating the average gray-scale may be reduced.

The switch 903 is provided to connect the output of the fixed voltage generating circuit 902 and all of the signal lines. The fixed voltage generating circuit 902 applies a gray-scale voltage depending on the average voltage, to all of the signal lines, during a signal-line fixed period LST. Note that the control timing of the switch 903 is the same as that of the switch 312 in the above-described first, second, and third embodiments.

The present embodiment has utilized the average gray-scale by way of one example, but may utilize a central gray-scale calculated from the maximum gray-scale and the minimum gray-scale of the display data. Additionally, there may be provided the non-overlapping period NO during which all the scanning lines are not selected similarly to the third embodiment.

By adopting the above-described circuit configuration, even if the drive method in which the alternating-current period is changed in the form of the frame period is used, it is possible to reduce the image quality deterioration called vertical smear and to achieve both of low-power consumption and high-image quality.

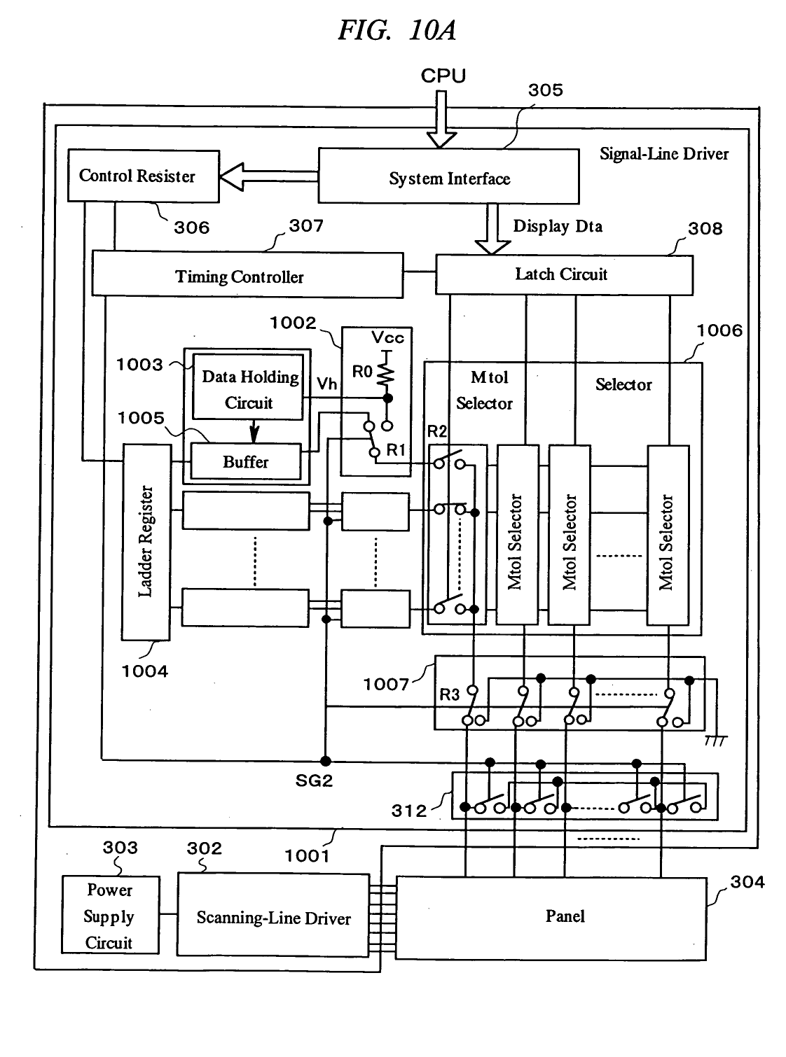

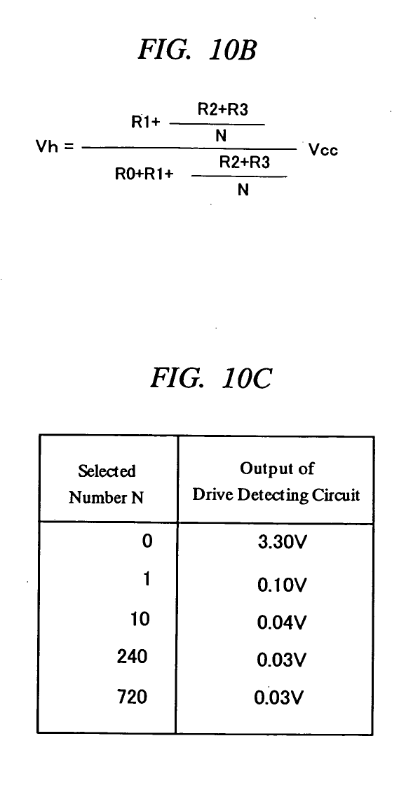

A configuration of a liquid crystal display device according to a fifth embodiment of the present invention will be described using FIG. 10. In a fifth embodiment of the present invention, the above-described signal-line short-circuit period is used to detect a type of gray-scale voltages outputted to the signal lines, and supplying the power source to the driver is stopped in the unused gray-scale voltage, whereby low-power consumption can further be achieved.

FIG. 10A is a block diagram of a liquid crystal display device according to a fifth embodiment of the present invention, wherein this embodiment is characterized by components denoted by the reference numerals “1001 to 1007”. The reference numeral “1001” is a signal-line driver; “1002” a drive detecting circuit; “1003” a data holding circuit; “1004” a ladder resistor; “1005” a buffer; “1006” a selector; and “1007” a switch. Note that the combination of the ladder resistor 1004, the buffer 1005, and the selector 1006 corresponds to the gray-scale voltage generating circuit 309 in the first, second, third and fourth embodiments. Additionally, other components except them are the same as those of the first embodiment of the present invention, and so a description thereof will be omitted.

The drive detecting circuit 1002 is a circuit for making a detection of whether each gray-scale is outputted to the signal line, and, as shown in FIG. 10A, comprises a 3-terminal switch and a resistor R1 for example. In this case, the operation of the drive detecting circuit 1002 is controlled by the above-described signal line SG2, wherein the connection between the buffer 1005 and the selector 1006 are released and the switch in the circuit 1002 is connected to a side of the resistor R1 during the signal-line short-circuit period and the buffer 1005 and the selector 1006 are connected during a gray-scale voltage applying period. In conjunction with this, the switch 1007 connects the output of the selector 1006 to the GND during the signal-line short-circuit period and connects the output of the selector 1006 to the switch 312 during the gray-scale voltage applying period. These operations can follow the invention's concept that all of the signal lines are short-circuited during the signal-lines short-circuit period and the gray-scale voltage depending on the display data is applied to the signal lines during the gray-scale voltage applying period. Next, detection of an operating condition of the gray-scale voltage, which is a feature of the present embodiment, will be described.

Firstly, in the case of paying attention to a gray-scale voltage Vn, at least one of the selectors 1006 selects the voltage Vn if a gray-scale that uses the voltage Vn is included in the transferred display data. For this reason, in the drive detecting circuit 1002 taking charge of the gray-scale voltage Vn, a penetration current through the power supply voltage Vcc-GND flows during the signal-line short-circuit period. Meanwhile, if the gray-scale that uses the voltage Vn is not included in the transferred display data, all of the selectors 1006 do not select the voltage Vn. As a result, in the drive detecting circuit 1002 taking charge of the gray-scale voltage Vn, the penetration current through the power supply voltage Vcc-GND does not flow during the signal-line short-circuit period. A state of the penetration current reflects a voltage Vh between the resistor R0 and the switch in the drive detecting circuit 1002. For example, if the power supply voltage Vcc is 3.3 V and a value of the resistor R1 is 1 MΩ and each value of the on-resistances R1 to R3 of the switches is 10 kΩ, the voltage Vh follows a formula in FIG. 10B and is, as shown in FIG. 10C, about 0 V when any one of the gray-scale voltages in the selectors 1006 is selected and is 3.3V when none of the gray-scale voltages is selected. That is, the voltage Vh can be used as a digital value.

The data holding circuit 1003 is a block for holding the voltage Vh outputted from the drive detecting circuit 1002 up to the gray-scale voltage applying period. For example, the data holding circuit 1003 can easily be achieved by using the latch circuit, which is reset at a time of starting of the one scanning period and holds the voltage Vh at a time of ending of the signal-line short-circuit period.

The buffer 1005 comprises Op-AMP circuits for impedance-converting the gray-scale voltage generated by the ladder resistor 1004. Each Op-AMP circuit turns on or off an operation of the amplifier based on the drive information from the data holding circuit 1003. Specifically, if the drive information from the data holding circuit 1003 is “0” (any one of the gray-scale voltages in the selectors 1006 is selected), the operation of the amplifier becomes in an ON state. If the drive information from the data holding circuit 1003 is “1” (none of the gray-scale voltages in the selectors 1006 is selected), the operation of the amplifier becomes in an OFF state.

By the circuit configuration and the operation timing as described above, the signal-line short-circuit period in the signal-line short-circuit method is used to detect the type of gray-scale voltages outputted to the signal lines, so that the supply of the power source to the driver can be stopped in the unused gray-scale voltage. Therefore, the lower-power consumption can be further achieved. Note that although the present embodiment has been described by premising the first embodiment, it may be described by combination of the second, third, and fourth embodiments. Additionally, respective circuit configurations of the drive detecting circuit 1002, the data holding circuit 1003, and the switch 1007 are not limited to those in this embodiment, and so long as any circuit configuration can obtain the information of the gray-scale voltage to be used during the signal-line short-circuit period, it may be adopted in view of the above concept.

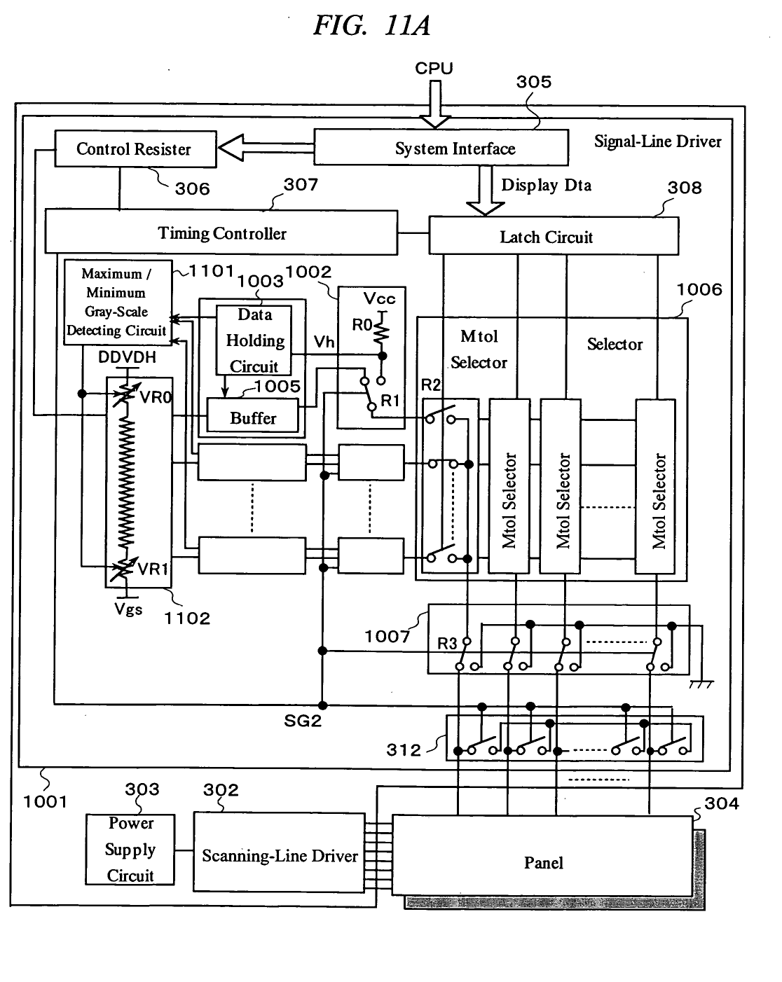

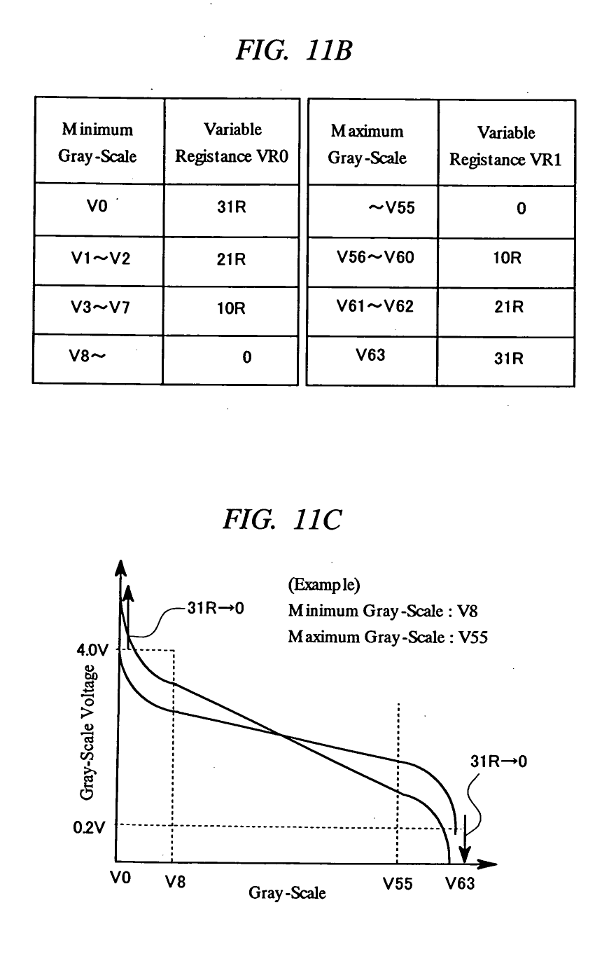

A configuration of a liquid crystal display device according to a sixth embodiment of the present invention will be described using FIG. 11. Generally, there is a function called an automatic contrast correction, as a technique for improving a sense of clarity of display image by enlarging a dynamic range of the image. A sixth embodiment of the present invention utilizes the information on the used gray-scale described in the fifth embodiment to achieve the automatic contrast correction. More specifically, the minimum gray-scale and the maximum gray-scale of the one-screen display data are determined by the information on the used gray-scale, and the dynamic range (amplitude value) of the gray-scale voltage levels is changed based on these determined values.

FIG. 11 is a block diagram of a liquid crystal display panel according to a sixth embodiment of the present invention, and this embodiment is characterized by the reference numerals “1101” and “1102”, wherein the reference numeral “1101” denotes a maximum/minimum gray-scale detecting circuit; and “1102” a ladder resistor having variable resistors VR0 and VR1 on both ends thereof. Note that other components except them are the same as those of the fifth embodiment and so a description thereof will be omitted.

The maximum/minimum gray-scale detecting circuit 1101 is a block for detecting the maximum gray-scale and the minimum gray-scale of the one-screen display data from the information on the used gray-scale that is transferred from the data holding circuit per scanning period. For example, this operation is sequentially updated after the maximum gray-scale and the minimum gray-scale per scanning period are compared to the maximum gray-scale and the minimum gray-scale of the previous scanning period. That is, the maximum gray-scale and the minimum gray-scale updated up to the final line are the one-screen maximum gray-scale and the one-screen minimum gray-scale, and the above operation can be performed by outputting those values during the next frame period.

The ladder resistor 1102 is a block for adjusting the values of the variable resistors provided in the ladder resistor in accordance with the data of the maximum gray-scale and the data of the minimum gray-scale outputted from the maximum/minimum gray-scale detecting circuit 1101. For example, in the case where the maximum gray-scale and the minimum gray-scale obtained from the above-described block are within a range in which the display data can be displayed (e.g., “0” to “63”), if the value of the ladder resistor is set to be less than a reference value in accordance with a displayed amount in the range, the dynamic range of the image, which is the object of the present invention, can be enlarged. One specific example of this operation is shown in FIGS. 11B and 1C. Note that the maximum and minimum gray-scales are easily converted to the control signals for variable resistors by using a table. Additionally, if the values of the table can be changed from the outside (e.g., MPUs in cellular phones or MPUs in personal computers) using the register, magnitude of the effect thereof can be adjusted.

According to the above-described sixth embodiment, since the signal-line short-circuit period in the signal-line short-circuit method is used to detect the type of the gray-scale voltages outputted to the signal lines, it is possible to stop the supply of the power source to the driver in the unused gray-scale voltages and to achieve the automatic contrast correction for enlarging the dynamic range for image in accordance with the information on the unused gray-scale. Therefore, higher-quality image display can be achieved while the low-power consumption is maintained.

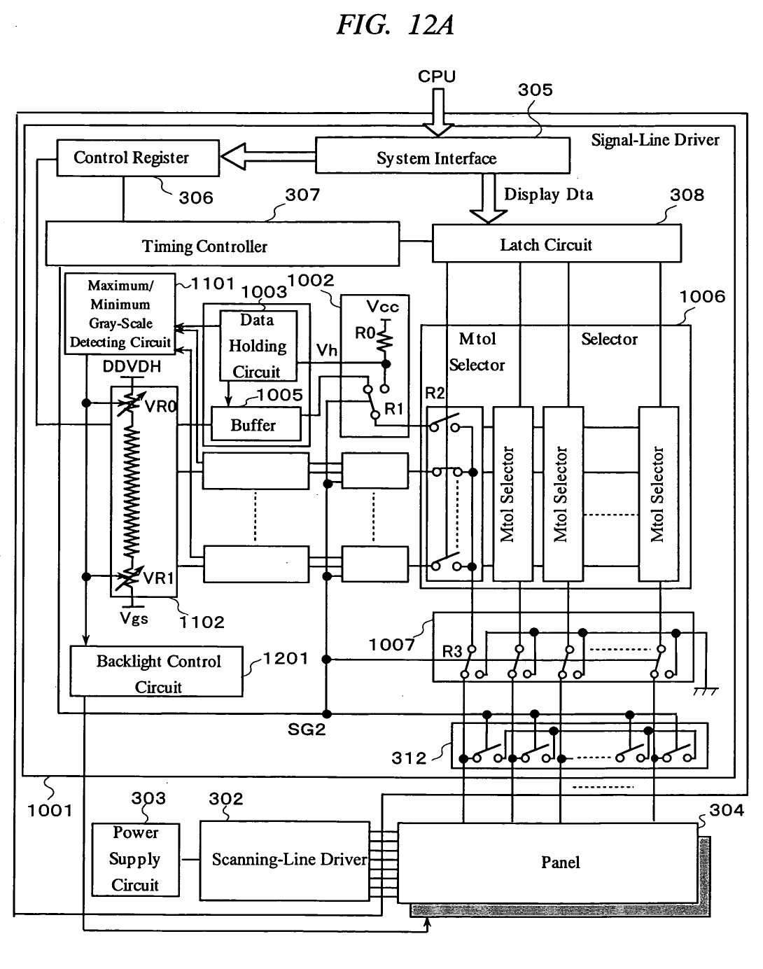

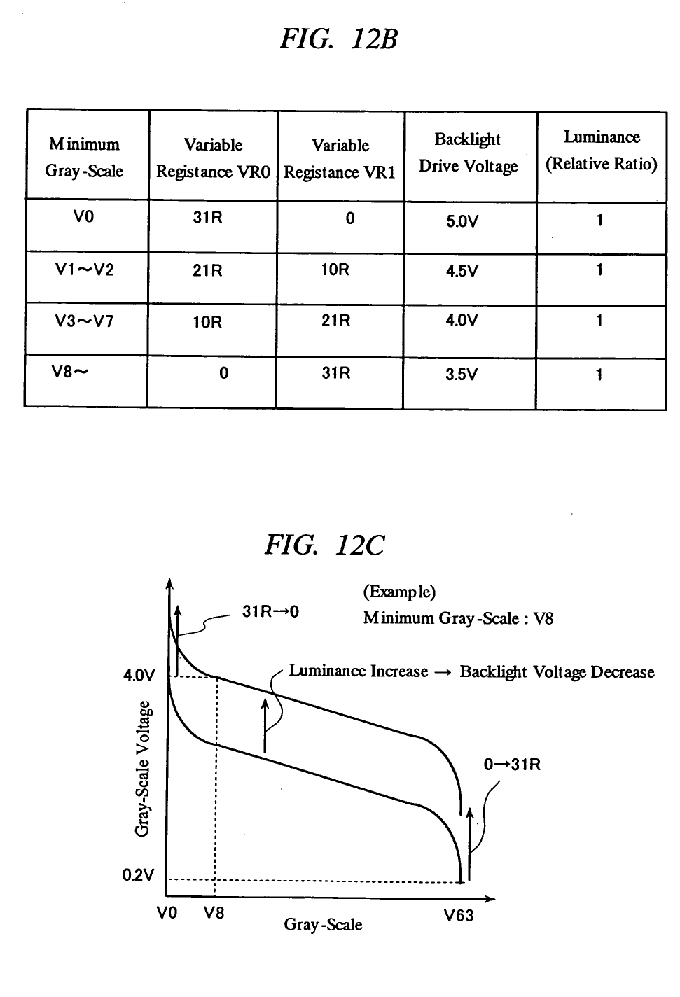

A configuration of a liquid crystal display device according to a seventh embodiment of the present invention will be described using FIG. 12.

In a seventh embodiment of the present invention, an offset (amplitude value) of the gray-scale voltage level and luminance of a backlight are controlled based on the minimum gray-scale of the one-screen display data described in the above sixth embodiment, so that low-power consumption of the backlight is achieved.

FIG. 12A is a block diagram showing a configuration of a liquid crystal display device according to the present embodiment, wherein the reference numeral “1201” denotes a backlight control circuit. Note that other components except it are the same as those of the sixth embodiment and so a description thereof will be omitted.

The backlight control circuit 1201 is a block for controlling the backlight luminance based on the minimum gray-scale of the one-screen display data outputted from the maximum/minimum gray-scale detecting circuit 1101. For example, in the case where the minimum gray-scale obtained from the above-described block is larger than values displayable as the display data (e.g., “0”), if the value of the ladder resistor VR0 is set to be less than the reference value and the value of the ladder resistor VR1 is set to be larger than the reference value in accordance with an amount of displayable values, the entire display luminance is increased. Then, when the backlight luminance is decreased in accordance with the increased display luminance, the desired display luminance can be recovered. As a result of this operation, power consumption of the backlight can be reduced without fluctuations of the display luminance. One specific example of the above operation is shown in FIGS. 12B and 12C. Note that conversion from the minimum gray-scale to the signals for controlling the backlight and the variable resistors can be easily achieved by using the table. Also, if the values of the table can be changed from the outside by using the register, the magnitude of the effect can be adjusted. Note that there are some methods of controlling the backlight luminance by varying a drive voltage and/or a lightning-up time, etc. However, so long as any method can control the luminance, it may be applied.

By the above-described seventh embodiment, since the signal-line short-circuit period in the signal-line short-circuit method is used to detect the type of the gray-scale voltages outputted to the signal lines, it is possible to stop the supply of the power source to the driver in the unused gray-scale voltage and to changed the offset (amplitude value) of the gray-scale voltage level and the backlight luminance in accordance with the information on the unused gray-scale voltage. Therefore, the lower-power-consumption display operation can be realized.

1. A driver for driving a display device having a plurality of signal lines arranged in a first direction, a plurality of scanning lines arranged in a second direction intersecting with said first direction, and a plurality of pixels provided to correspond to intersections of said plurality of signal lines and said plurality of scanning lines, each of said pixels having a pixel electrode connected to said signal line through a capacitance and a switching element whose first terminal is connected to said signal line, second terminal is connected to said scanning line, and third terminal is connected to said pixel electrode, the driver comprising:
a converter for converting inputted display data to a gray-scale voltage and for outputting said gray-scale voltage to said signal lines; and
a switching circuit for opening/closing a first electrical coupling provided between the signal line and said converter and for opening/closing a second electrical coupling provided between said plurality of signal lines,
wherein one scanning period for scanning said scanning lines includes a first period during which said switching circuit closes said first electrical coupling and opens said second electrical coupling, and a second period during which said switching circuit opens said first electrical coupling and closes said second electrical coupling.

2. The driver according to claim 1,
wherein a ratio of said first period to said second period is determined depending on a signal inputted from the outside.

3. The driver according to claim 1,
wherein said one scanning period includes a selecting period during which said pixels on said scanning lines are selected and a non-selecting period during which said pixels on said scanning lines are not selected, and
said non-selecting period in said one scanning period includes said second period.

4. A driver for driving a display device having a plurality of signal lines arranged in a first direction, a plurality of scanning lines arranged in a second direction intersecting with said first direction, and a plurality of pixels provided to correspond to intersections of said plurality of signal lines and said plurality of scanning lines, each of said pixels having a pixel electrode connected to said signal line through a capacitance and a switching element whose first terminal is connected to said signal line, second terminal is connected to said scanning line, and third terminal is connected to said pixel electrode, the driver comprising:
a converter for converting inputted display data to a gray-scale voltage and for outputting said gray-scale voltage to said signal lines;
a switching circuit for opening/closing a first electrical coupling provided between the signal line and said converter and for opening/closing a second electrical coupling provided between said plurality of signal lines; and
a output circuit for outputting, to said signal lines, another voltage other than said gray-scale voltage converted from said display data,
wherein one scanning period for scanning said scanning lines includes a first period during which said switching circuit closes said first electrical coupling and opens said second electrical coupling and sad converter applies said gray-scale voltage to said signal lines, and a second period during which said switching circuit opens said first electrical coupling and closes said second electrical coupling and said output circuit applies said another voltage to said signal lines.

5. The driver according to claim 4,
wherein said output circuit generates said another voltage per said one scanning period based on a display data group for an pixel group scanned during said one scanning period.

6. The driver according to clime 5,
wherein said output circuit generates said another voltage per said one scanning period by averaging said gray-scale voltage group supplied to the pixel group scanned during said one scanning period.

7. The driver according to claim 4,
wherein a ratio of said first period to said second period is determined by a signal inputted from the outside.

8. The driver according to claim 4,
wherein said one scanning period includes a selecting period during which the pixels on said scanning lines are selected and a non-selecting period during which the pixels on said scanning lines are not selected, and
said non-selecting period in said one scanning period includes said second period.

9. The driver according to claim 4,
wherein a polarity of a voltage applied to an optical modulating layer or a light emitting layer of each of said pixels is reversed depending on a frame period.

10. The driver according to claim 4,
wherein said display device is a liquid crystal panel or an electroluminescent display panel.

11. A driver for driving a display device having a plurality of signal lines arranged in a first direction, a plurality of scanning lines arranged in a second direction intersecting with said first direction, and a plurality of pixels provided to correspond to intersections of said plurality of signal lines and said plurality of scanning lines, each of said pixels having a pixel electrode connected to said signal line through a capacitance and a switching element whose first terminal is connected to said signal line, second terminal is connected to said scanning line, and third terminal is connected to said pixel electrode, the driver comprising:
a resistor for generating a plurality of gray-scale voltages from a reference voltage;
an Op-AMP for impedance-converting an output of said resistor;
a selector for selecting a gray-scale voltage corresponding to inputted display data among said plurality of gray-scale voltages from the Op-AMP; and
a switching circuit for opening/closing a first electrical coupling provided between said Op-AMP and said selector, a second electrical coupling provided said Op-AMP and power supply, a third electrical coupling provided between said selector and ground, and a fourth electrical coupling provided between said plurality of signal lines,
wherein one scanning period for scanning said scanning lines includes a first period during which said switching circuit closes said first electrical coupling and opens said second to fourth electrical couplings, and a second period during which said switching circuit opens said first electrical coupling and closes said second to fourth electrical couplings, and
supplying the power supply to the Op-AMP during said first period is stopped in accordance with a voltage level of said switching circuit for opening/closing said second electrical coupling during said second period.

12. The driver according to claim 11,
wherein a ratio of said first period to said second period is determined by a signal inputted from the outside.

13. A driver for driving a display device having a plurality of signal lines arranged in a first direction, a plurality of scanning lines arranged in a second direction intersecting with said first direction, and a plurality of pixels provided to correspond to intersections of said plurality of signal lines and said plurality of scanning lines, each of said pixels having a pixel electrode connected to said signal line through a capacitance and a switching element whose first terminal is connected to said signal line, second terminal is connected to said scanning line, and third terminal is connected to said pixel electrode, the driver comprising:
a resistor for generating a plurality of gray-scale voltages from a reference voltage;
an Op-AMP for impedance-converting an output of said resistor;
a selector for selecting a gray-scale voltage corresponding to inputted display data among said plurality of gray-scale voltages from the Op-AMP; and
a switching circuit for opening/closing a first electrical coupling provided between said Op-AMP and said selector, a second electrical coupling provided said Op-AMP and power supply, a third electrical coupling provided between said selector and ground, and a fourth electrical coupling provided between said plurality of signal lines,
wherein one scanning period for scanning said scanning lines includes a first period during which said switching circuit closes said first electrical coupling and opens said second to fourth electrical couplings, and a second period during which said switching circuit opens said first electrical coupling and closes said second to fourth electrical couplings, and
supplying the power supply to said Op-AMP during said first period is stopped in accordance with a voltage level of said switching circuit for opening/closing said second electrical coupling during said second period, and a dynamic range of said resistor is changed in accordance with the voltage level of said switching circuit for opening/closing said second electrical coupling during said second period.

14. The driver according to claim 13,
wherein a ratio of said first period to said second period is determined by a signal inputted from the outside.

15. A driver for driving a display device having a plurality of signal lines arranged in a first direction, a plurality of scanning lines arranged in a second direction intersecting with said first direction, a plurality of pixels provided to correspond to intersections of said plurality of signal lines and said plurality of scanning lines, and a light source for irradiating said pixels, each of said pixels having a pixel electrode connected to said signal line through a capacitance and a switching element whose first terminal is connected to said signal line, second terminal is connected to said scanning line, and third terminal is connected to said pixel electrode, the driver comprising:
a resistor for generating a plurality of gray-scale voltages from a reference voltage;
an Op-AMP for impedance-converting an output of said resistor;
a selector for selecting a gray-scale voltage corresponding to inputted display data among said plurality of gray-scale voltages from the Op-AMP; and
a switching circuit for opening/closing a first electrical coupling provided between said Op-AMP and said selector, a second electrical coupling provided said Op-AMP and power supply, a third electrical coupling provided between said selector and ground, and a fourth electrical coupling provided between said plurality of signal lines,
wherein one scanning period for scanning said scanning lines includes a first period during which said switching circuit closes said first electrical coupling and opens said second to fourth electrical couplings, and a second period during which said switching circuit opens said first electrical coupling and closes said second to fourth electrical couplings, and
supplying the power supply to said Op-AMP during said first period is stopped in accordance with a voltage level of said switching circuit for opening/closing said second electrical coupling during said second period, and a dynamic range of said resistor is changed in accordance with the voltage level of said switching circuit for opening/closing said second electrical coupling during said second period, and luminance of said light source is changed in accordance with the voltage level of said switching circuit for opening/closing said second electrical coupling during said second period.

16. The driver according to claim 15,
wherein a ratio of said first period to said second period is determined by a signal inputted from the outside.
